(19) United States
(12) Patent Application Publication
(10) Pub. No.: US 2021/0158644 A1
(43) Pub. Date: May 27, 2021

(54) PEER PARTITIONING TO REDUCE STRATEGY-DRIVEN BIAS IN AUTOMATED PEER-SELECTION SYSTEMS

(71) Applicant: INTERNATIONAL BUSINESS MACHINES CORPORATION, ARMONK, NY (US)

(72) Inventors: Ramasuri Narayanam, ANDHRA PRADESH (IN); Gopal Bhageria, Kolkata (IN); Radha Bellamkonda, Hyderabad (IN)

(21) Appl. No.: 16/692,182

(22) Filed: Nov. 22, 2019

(51) Int. Cl. G07C 13/00; H04L 29/08

(52) U.S. Cl. CPC G07C 13/00; G06Q 2230/00; H04L 67/104

(57) ABSTRACT

A peer-selection component of a peer-to-peer network detects a selection event in which network users vote to select a certain number of their peers. The system splits the voting community into two partitions and the number of peers to be selected from each partition is divided in proportion to the relative partition sizes. The system moves peers between partitions to maximize the number of interpartition votes, which are votes cast by a peer in one partition for a peer in another partition. Each peer's “indegree” value is defined as the number of the peer's incoming interpartition votes. Peers with indegree values greater than zero tentatively qualify for selection. The partitioning process repeats until every partition can provide at least the number of selected peers allocated to that partition. The final selection is forwarded to the downstream applications that initiated the selection event.

### BACKGROUND

The present invention relates in general to peer-selection and crowdsourcing technologies and in particular to reducing the ability of peers to tamper with voting results.

Automated peer-selection systems, such as crowdsourcing applications, allow a participant to be selected by peer voters/participants, rather than by objective criteria. For example, a peer-selection system operated by a research-funding source may select studies to fund by allowing a community of academic peers to electronically “vote” for worthy proposals. Similar mechanisms are used in applications that employ peer selection to choose articles for publication in a peer-reviewed journal or for presentation in a conference, to select computer code or algorithms from a set of proposed code segments or candidate algorithms, to choose the best proposals received in response to a request for proposal, or to identify which students should receive awards upon graduation.

### SUMMARY

Embodiments of the present invention comprise systems, methods, and computer program products for reducing strategy-driven bias in an automated peer-selection application. A peer-selection component of a peer-to-peer network detects an ongoing peer-selection event in which peer users of the peer-to-peer network each cast votes for other peers of the same network. The ultimate outcome of the voting is to select a predetermined number of peers for an award or other distinction. The system splits the voting community into two partitions by any means desired by an implementer. The number of peers to be selected from each partition is divided in a similar manner, in proportion to the relative numbers of peers in each partition. The system migrates peers between partitions to maximize the number of interpartition votes, which are votes cast by a peer in one partition for a peer in another partition, and to minimize the number of intrapartition votes, which are votes in which a voting peer and the peer for whom the voting peer casts a vote are in the same partition. Each peer's “indegree” value is defined as the number of the peer's incoming interpartition votes. Peers with indegree values greater than zero (“positive-indegree peers”) tentatively qualify for inclusion in the solution set. The partitioning process repeats until every partition contains the number of positive-indegree peers specified by that partition's required number of selected peers. The set of all positive-indegree peers is designated to be the final desired outcome and is forwarded as a solution set to the downstream applications that initiated the selection event.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for peer partitioning to reduce strategy-driven bias in automated peer-selection systems in accordance with embodiments of the present invention.

FIG. 4A shows an exemplary topology of a peer-selection network.

FIG. 4B shows an example of an unperturbed voting configuration of the peer-selection network of FIG. 4A.

FIG. 4C shows a perturbed voting configuration of the peer-selection network of FIG. 4A, generated by peer manipulations intended to produce biased results.

FIG. 5A is a second example of a peer-selection network.

FIG. 5B shows an inefficient partitioning of the peer-selection network of FIG. 5A that may produce biased results.

FIG. 5C shows an efficient and desirable partitioning of the peer-selection network of FIG. 5A that identifies an ideal peer-selection solution set.

FIG. 6 is a flow chart that illustrates steps of a method for peer partitioning to reduce strategy-driven bias in automated peer-selection systems in accordance with embodiments of the present invention.

FIG. 7 is a flow chart that illustrates details of the partitioning process of step 620 of FIG. 6, in accordance with embodiments of the present invention.

### DETAILED DESCRIPTION

Automated peer-selection mechanisms, such as crowdsourcing efforts, allow an agent to be selected by peer agents, rather than by objective criteria. For example, a research-funding source may select studies to fund by asking academic peers to electronically “vote” for the most worthy proposals. Similar mechanisms can be used to select articles for publication in a peer-reviewed journal or for presentation in a conference, to choose a set of bidders from among respondents to a request for proposal, or to identify students who should receive awards upon graduation.

Like traditional voting mechanisms, electronic peer-selection may be vulnerable to tampering. For example, a subset of voters may collude to bias selection results by voting in concert for a specific candidate, causing that candidate to be selected because the density of the colluding votes allows them to overwhelm the more uniform distribution of votes received by other candidates. In another example, two voters, or two subsets of voters, might agree to vote for each other in order to unfairly increase their chances of selection.

This flaw in peer-selection systems, sometimes referred to as the “peer-selection problem,” has long been viewed as an unavoidable consequence of selection systems in which a participant may be both a candidate and a voter. The problem has become more pronounced with the emergence of crowdsourcing and other types of automated peer-selection systems, where voter/candidates are organized into large, complex, and continuously varying computer networks. Such networks are difficult to monitor and provide unprecedented opportunities for collusion that is in practice undetectable.

Embodiments of the present invention provide a technological solution to instances of the peer-selection problem that occur in computerized peer-selection environments, such as a crowdsourcing platform. This solution takes advantage of the computerized nature of such instances by using the dynamic nature of virtual and other types of dynamically configurable networks to continuously repartition a voting community in order to minimize or eliminate the possibility of the most likely types of collusion.

This solution cannot be migrated to a noncomputerized voting mechanism because the solution requires the ability to dynamically partition peers that make up a voting community in response to ongoing voting behavior, and to dynamically adjust the manner in which votes are counted in response to the dynamic partitioning. Votes are not counted in a normal manner, but are filtered as a function of dynamic partitioning that continuously divides a voting community into optimized partitions that infer, as a function of partition boundaries, which votes should be counted, and which votes should be discarded in response to a statistical likelihood that the votes are the result of attempts to bias the voting results.

In this manner, embodiments of the present invention use technological means to address instances of the peer selection problem that occur in crowdsourcing applications, automated peer-review mechanisms, and other types of computerized peer-review systems.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

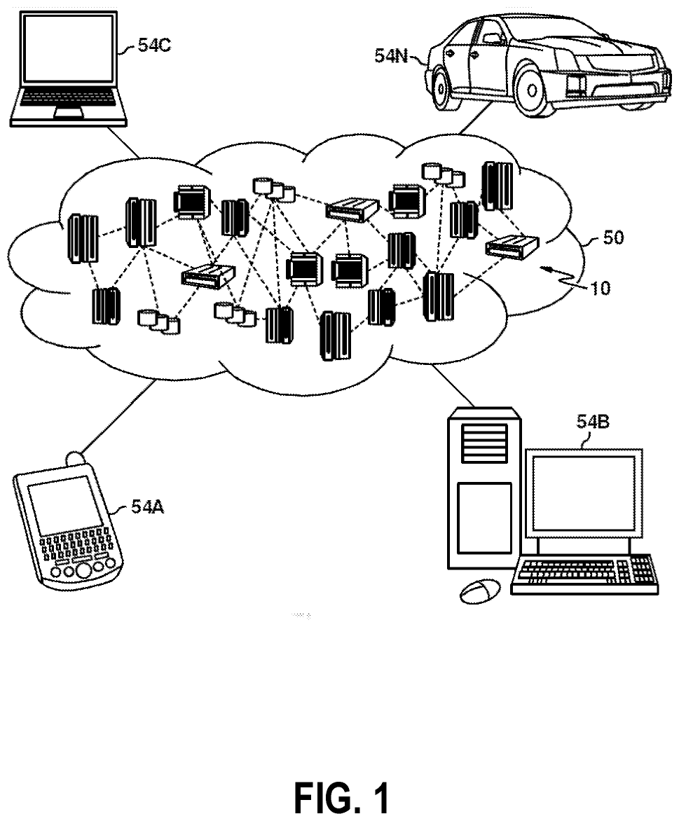

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

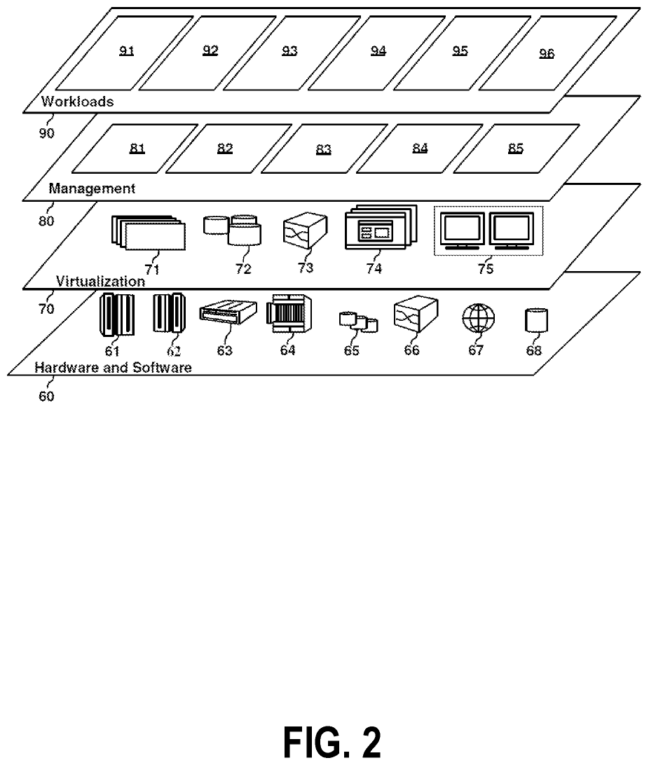

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and orchestration of methods and systems for peer partitioning to reduce strategy-driven bias in automated peer-selection systems 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

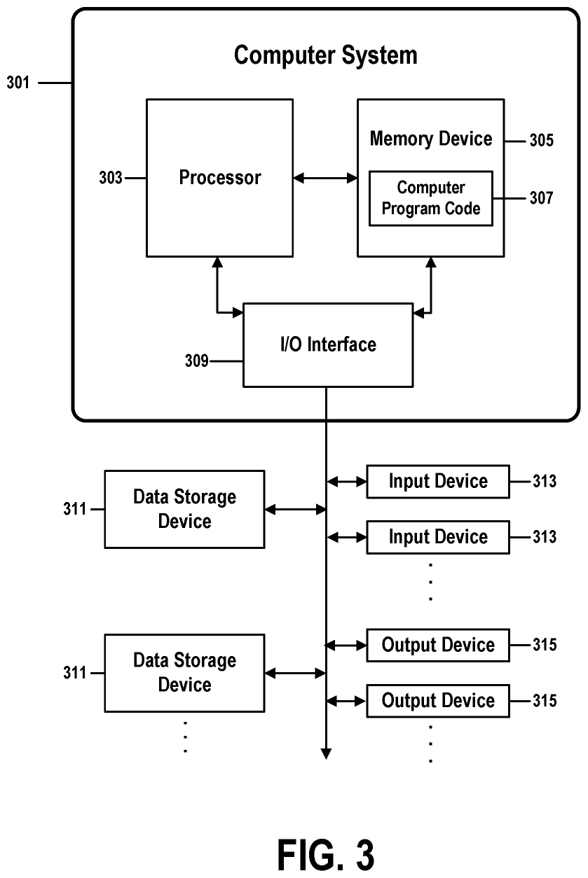

FIG. 3 shows a structure of a computer system and computer program code that may be used to implement a method for peer partitioning to reduce strategy-driven bias in automated peer-selection systems in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackballs, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 305 contains stored computer program code 307, which is a computer program that comprises computer-executable instructions. The stored computer program code includes a program that implements a method for peer partitioning to reduce strategy-driven bias in automated peer-selection systems in accordance with embodiments of the present invention, and may implement other embodiments described in this specification, including the methods illustrated in FIGS. 1-7. The data storage devices 311 may store the computer program code 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware, or may be accessed by processor 303 directly from such firmware, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for peer partitioning to reduce strategy-driven bias in automated peer-selection systems.

Any of the components of the present invention could be created, integrated, hosted, maintained, deployed, managed, serviced, supported, etc. by a service provider who offers to facilitate a method for peer partitioning to reduce strategy-driven bias in automated peer-selection systems. Thus the present invention discloses a process for deploying or integrating computing infrastructure, comprising integrating computer-readable code into the computer system 301, wherein the code in combination with the computer system 301 is capable of performing a method for peer partitioning to reduce strategy-driven bias in automated peer-selection systems.

One or more data storage devices 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for peer partitioning to reduce strategy-driven bias in automated peer-selection systems may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for peer partitioning to reduce strategy-driven bias in automated peer-selection systems is integrated into a client, server and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

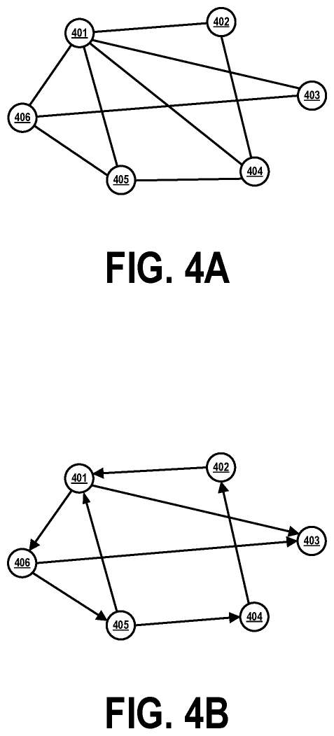

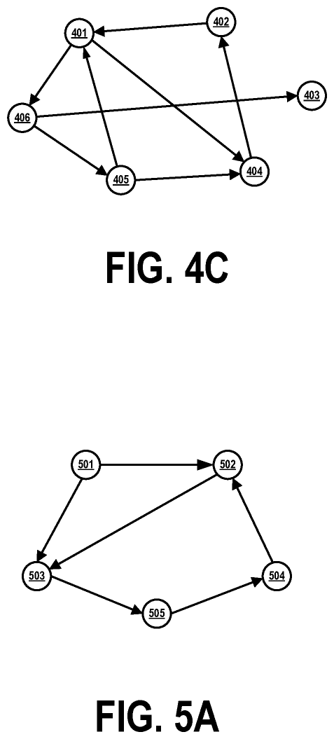

FIGS. 4A-4C illustrate one type of problem, intrinsic to automated peer-selection networks, that embodiments of the present invention are intended to address.

FIG. 4A shows a topology of a peer-selection network represented by a graph. FIG. 4A shows items 401-406.

In this network, six nodes 401-406 each represent one voting peer. Each peer 401-406 may vote for one or more neighboring peers 401-406, where two peers are deemed to be neighboring if the two peers are represented by nodes that are directly connected by a single edge.

The graph may represent any sort of peer-selection network known in the art, such as a network of academic peers in which the peers receiving the greatest number of votes are selected to receive an award or a team of peer software designers in which the peer voting is intended to determine which designer's particular set of computer instructions will included in an application that is under development by the team.

FIG. 4B shows an example of an unperturbed voting configuration of the peer-selection network of FIG. 4A. FIG. 4B shows items 401-406. Items 401-406 are identical in form and function to identically numbered items in FIG. 4A.

Here, each directed edge points from a voting node to a voted node. For example, the directed edge from node 404 to node 402 represents a vote, by peer 404, for peer 402. In this example, the graph indicates that peers 401 and 403 receive the greatest number of votes because both two edges are directed to each of nodes 401 and 403, while no other node receives more than one vote.

FIG. 4C shows a perturbed voting configuration of the peer-selection network of FIG. 4A, generated by peer manipulations intended to produce biased results. FIG. 4C shows items 401-406. Items 401-406 are identical in form and function to identically numbered items in FIGS. 4A and 4B.

In this example, an alliance between peers 401 and 404 has altered the supposedly unbiased results of FIG. 4B. By redirecting its vote from peer 403 to peer 404, peer 401 has ensured that peers 401 and 404 are the only two peers that receive two votes. This manipulation prevents peer 403 from being rightfully selected.

This and other types of collusion and quid pro quo arrangements, sometimes described as examples of the “peer-selection problem,” are possible in voting communities where each participant is both a candidate and a voter. As will be described in subsequent figures, embodiments of the present invention address this problem by dynamically partitioning and restructuring the user community to minimize or eliminate the possibility that peer selection results can be altered by such behavior.

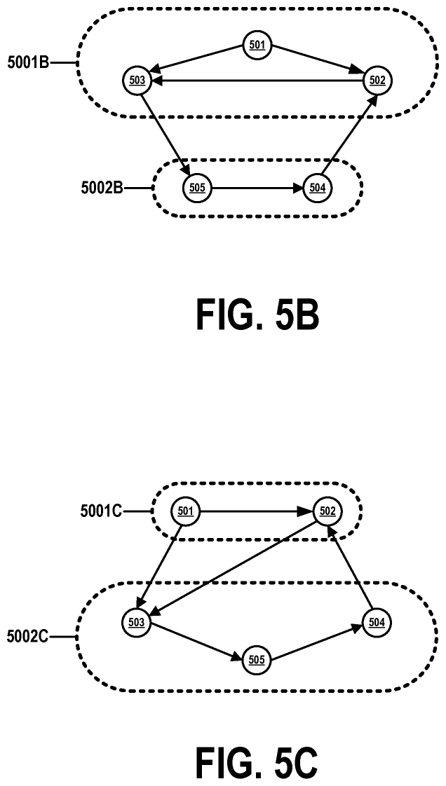

FIG. 5A is a second example of a peer-selection network. FIG. 5B shows items 501-505.

As in the graphs of FIGS. 4A-4C, nodes 501-505 each represent one voting peer in a peer-selection network. Each directed edge represents a positive vote by one peer 501-505 for a neighboring peer 501-505. As in the previous figures, FIG. 5A shows only positive votes, which a vote increments a recipient's status and increases the likelihood that the recipient will be included in the peer-selection processes solution set. FIG. 5A, like all other figures in this document, do not show negative votes, which decrease the likelihood that a recipient will be selected for the solution set.

In FIG. 5A, for example, the edge pointing from peer 501 to peer 502 represents a positive vote by peer 501 for peer 502. This convention shows that peer 502 receives two votes, from peers 501 and 504, and in turn votes for peer 503. The other edges represent similar peer voting. If a peer-selection solution set for this graph is configured to contain the two peers that receive the highest number of votes, the solution set will contain nodes 502 and 503, each of which receives two votes. No other node shown in FIG. 5A receives more than one vote. The solution set {502, 503} is thus the optimal, correct solution set when votes are tallied without interference by a voter strategy that attempts to bias the peer-selection results.

FIG. 5B shows an inefficient partitioning of the peer-selection network of FIG. 5A that may produce biased results. FIG. 5B shows items 501-505 and 5001B-5002B. Items 501-505 are identical in form and function to identically numbered items in FIG. 5A.

Embodiments of the present invention use a specific type of partitioning, based on voting patterns, to partition a voting peer-selection community in a way that reduces the likelihood of user biasing. This partitioning procedure divides the community into discrete, mutually exclusive partitions and selects at most one peer from each partition. The resulting solution set will contain one peer from each partition. Each peer in the solution set will have received the greatest number of votes from peers in other partitions, while votes received from peers within the same partition are ignored. However, this mechanism is effective only when the partitioning is performed subject to certain constraints. Merely partitioning the community in an arbitrary manner does not necessarily produce the correct solution set.

For example, the inefficient partitioning shown in FIG. 5B arbitrarily divides FIG. 5A's peer-selection community of voters 501-505 into two partitions. Partition 5001B contains peers 501-503 and partition 5002B contains peers 504 and 505. According to embodiments of the present invention, a two-entry solution set will contain one peer from each partition, where that peer has received the greatest number of votes from peers in other partitions. Because peer 502 is the only peer of partition 5001A that receives a vote from partition 5002B, and because peer 505 is the only peer of partition 5001B that receives a vote from partition 5002A, the solution set would be {502, 505}. This would be an inaccurate result because, as was shown in FIG. 5A, the correct two-element solution set for this network is {502, 503}.

FIG. 5C shows an efficient and desirable partitioning of the peer-selection network of FIG. 5A that identifies an ideal peer-selection solution set. FIG. 5 shows items 501-505 and 5001C-5002C. Items 501-505 are identical in form and function to identically numbered items in FIGS. 5A and 5B.

In this figure, voters 501-505, which make up the peer-selection community of FIGS. 5A and 5B, are partitioned according to methods of the present invention into partitions 5001C and 5001D.

Using the methods of the present invention, which include in the solution set a predefined number of nodes from each partition, each node 501-505 is assigned a “total indegree” value equal to the number of node's incoming edges. However, the only edges that contribute to a node's indegree value are “interpartition” edges that cross partition boundaries.

For example, in FIG. 5C, node 502 of partition 5001C has a total indegree of 1 because node 502 has one incoming edge directed from node 504 of partition 5002C and one outgoing edge directed to node 503 of partition 5002C. The incoming edge directed from node 501 is not considered because both node 501 and node 502 are located in the same partition 5001C—and is therefore not considered an interpartition edge. Similarly, node 503 of partition 5001C has a total indegree of 2 because node 503 has two incoming edges directed from nodes of partition 5002C, and node 501 of partition 5001C has an indegree of 0 because no incoming edges are directed from partition 5002C to node 501.

In this limited example, node 502 is selected to be included in the solution set because node 502 has a positive indegree value and because no other node of partition 5001C has a greater total indegree than does node 502. Similarly, and node 503 is selected to be included in the solution set because node 503 has a positive indegree value and because no other node of partition 5002C has a greater total indegree value than does node 503. This partitioning thus produces the correct solution set {502,503}.

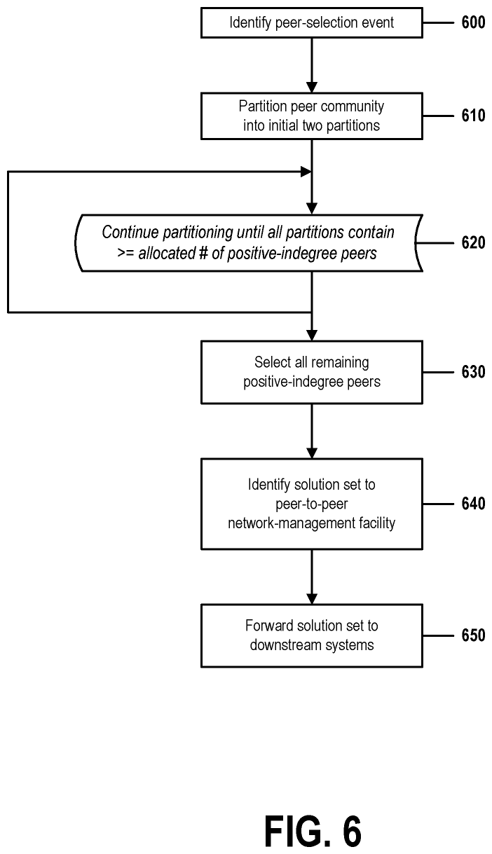

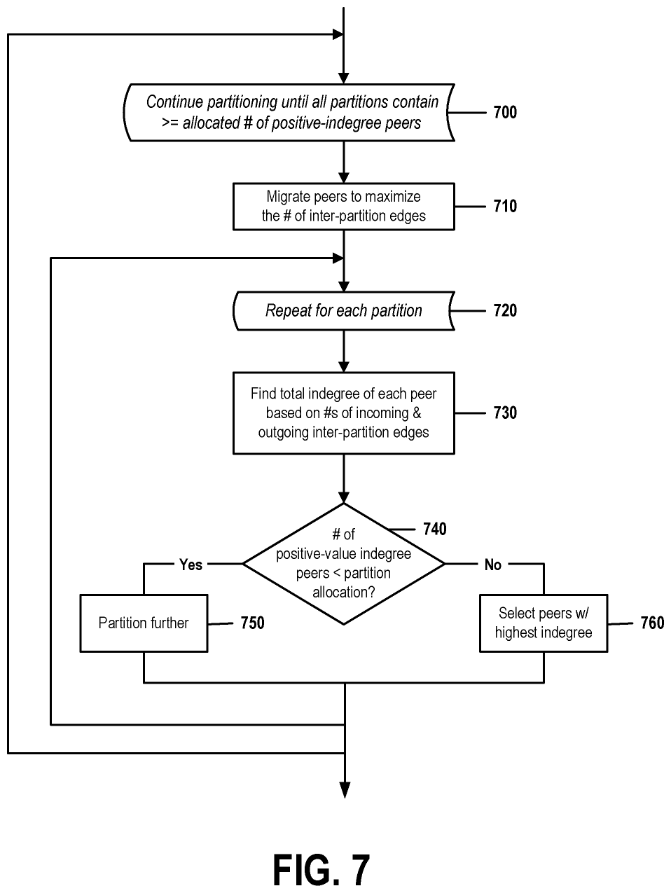

As will be explained below, the partitioning of FIG. 5C and the rules that produced the partitioning of FIG. 5C organize nodes 501-505 in such a manner as to minimize the possibility that a subset of voters 501-505 will be able to bias the voting results through collusion. One goal of the present invention, therefore, is to identify correct, unbiased peer-selection solution sets by partitioning voter communities in a manner similar to that of FIG. 5C, rather than that of FIG. 5B. This partitioning method will be described in greater detail in FIGS. 6 and 7.

FIG. 6 is a flow chart that illustrates steps of a method for peer partitioning to reduce strategy-driven bias in automated peer-selection systems in accordance with embodiments of the present invention. FIG. 6 contains steps 600-650.

In step 600, a peer-selection component or system of a peer-to-peer network-management system, or any other networked system or application that supports peer-to-peer communications, receives notice or otherwise identifies that a peer-selection event has been initiated.

As described above, the peer-selection event may be any sort of activity in which peers in the peer-to-peer network are allowed to cast “votes” for other peers in the network. The results of this voting will identify a solution set of one or more peers of the network. For example, in the exemplary peer-to-peer network of FIGS. 5A-5C, a selection activity directed to a two-element solution set selects a solution set that consists of peers 502 and 503 because peers 502 and 503 each receive a greater number of votes than does any other peer of the network.

The peer-selection system in this step may also identify certain details about the event that the system requires in order to perform steps of FIGS. 6 and 7. For example, the system may receive a listing of the peers eligible to cast votes, a description of the network topology that identifies each peer's direct neighbors, an enumeration of a set of peers for which a particular peer is allowed to vote, a size of a desired solution set, or a set of rules or conditions that specify characteristics of the selection event, such as a limit to the number of votes that a peer may cast or receive, a duration of time during which votes may be cast, weightings or other criteria that define relative degrees of consideration to be given to each peer's votes, conditions under which peers may be added to or deleted from the network, or a purpose associated with the selecting process.

In step 610, the peer-selection system partitions the peer community (such as the peers 401-406 of the peer-to-peer network of FIGS. 4A-4C or the peers 501-505 of the peer-to-peer network of FIGS. 5A-5C) into two partitions.

This initial partitioning may be performed by any means desired by an implementer, such as by arbitrarily dividing a peer community into two groups that each consist of a same number of peers. Because the partition membership will be fine-tuned by subsequent steps of FIGS. 6 and 7, the exact distribution of peers into the two initial partitions is not important. In some embodiments, however, better results can be obtained if the two partitions contain approximately the same number of member peers.

The solution set associated with the peer-selection event should be partitioned in proportion to the number of peers in each partition. In one example, consider a peer-to-peer community that consists of 1000 members and a peer-selection event's desired solution set that contains 10 entries. If the community is divided into two 500-member partitions, each of those partitions should be allocated five members of the solution set. Similarly, if the community is divided into a 700-member partition and a 300-member partition, three of the solution set's 10 entries should be selected from the first partition and seven of the solution set's 10 entries should be selected from the first partition. This dividing of the solution-set among partitions is referred to below as allocating a predefined number of solution-set entries to each partition.

As will be seen in FIG. 7, whenever a partition is divided into a pair of smaller sub-partitions, the portion of the solution set allocated to the partition is divided proportionally between the sub-partitions in a similar manner.

In step 620, the peer-selection system continues to divide the peer community more finely. The system performs this step repeatedly, each time dividing the current round of partitions into smaller partitions. The goal of the partitioning is to organize peers into partitions in order to maximize the number of positive votes received by each peer from peers located in a different partition, and to minimize the number of positive votes received by each peer from peers located in the same partition. The number of votes received by a peer from peer nodes located in a different partition is known as that peer's “total indegree.” A node to which a number of incoming edges directed from different partitions is greater than zero will thus be a “positive-indegree” node that has a total indegree value greater than zero.

Step 620 repeats until it is no longer possible for the system to further partition the peer community. This termination condition occurs when no partition contains less than a certain predefined number of “positive indegree” peers allocated to that partition. As explained above, a positive indegree peer is a peer that has received at least one positive vote from peers in external partitions (incoming edges) and is represented by a node that is the target of more than one incoming edges originating from other partitions. In other words, positive-indegree peers always have a total indegree value greater than zero.

FIG. 7 describes the method of step 620 in greater detail.

In step 630, the peer-selection system identifies and aggregates the positive-indegree peers identified by the iterative partitioning of step 620.

In step 640, the peer-selection system deems the positive-indegree peers identified in step 630 to be a solution set of the peer-selection event identified in step 600. For example, if the peer-selection event is a procedure by which members of a screen actor's guild select five nominees for a Best Actor award, the solution set might consist of five guild members that have the highest total indegree when the guild members are divided into an optimal set of partitions by iterations of step 620.

The peer-selection system forwards the solution set identified in step 630 to the peer-to-peer network-management system or other networked system or application that comprises or otherwise communicates with the peer-selection system. The recipient system identifies the received peer selection as the optimal solution set for the peer-selection event specified in step 600.

In step 650, the peer-selection system, management system, or other system or application forward the peer-selection results to one or more downstream systems. For example, if the solution set identifies a set of finalists in a live televised singing competition, the results might be forwarded to a system that scrolls the list of finalists across the screen of the televised competition. In other embodiments, those results might be forwarded to a downstream system to broadcasts the result to certain social-media services or to secured monitors visible only by the show's hosts.

In some embodiments, the solution set may vary continuously in real-time, as votes continue to be cast. In such cases, a downstream system may be configured to continuously update a displayed solution set in real time, in order to most accurately represent the latest voting tallies. An embodiment of the peer-selection system would support such an application by continuing to repeat the methods of FIGS. 6 and 7 in order to continuously update the solution set over time. If a similar embodiment does not require real-time output, the peer-selection system may periodically perform the methods of FIGS. 6 and 7 in order to update the solution set continually, but not continuously.

FIG. 7 is a flow chart that illustrates details of the partitioning process of step 620 of FIG. 6, in accordance with embodiments of the present invention. FIG. 7 contains steps 700-760.

Step 700 initiates an outer iterative procedure of steps 700-760. This procedure performs tasks comprised by the partitioning of step 620 of FIG. 6.

The peer-selection system of FIG. 6 repeats this procedure until it is no longer possible for the system to further partition the peer community. This termination condition occurs when the system in step 750 determines that no partition contains a number of “positive indegree” peers less than the number of “positive indegree” peers allocated to that partition. Embodiments of the present invention thus assume that voting has already begun or, in some cases, has concluded, at the time that this procedure is performed.

In certain embodiments, the iterative procedure of steps 700-760 is performed once for each partition, then repeated for each next-generation partition generated by the step of partitioning the current partition in step 760. In other embodiments, the procedure of steps 700-760 is performed once for every generation of partitions. In these latter partitions, the next iteration of steps 700-760 is then performed for the next generation of partitions generated by multiple instances of step 760.

In step 710, the peer-selection system migrates peers between pairs of partitions in order to maximize the number of edges that cross partition boundaries. In certain embodiments, this step will be performed iteratively for every possible pair of partitions in the community.

For example, the system in this step might repartition the community shown in FIG. 5B by moving peer 503 from partition 5001B to partition 5002B. This migration would result in the partitioning shown in FIG. 5C, in which node 503 is connected to a greater number of nodes in different partitions. In FIG. 5B, node 503 is connected by only one interpartition edge to node 505, but the partitioning of FIG. 5C results in node 503 being connected by interpartition edges to both nodes 501 and 502.

These migrations may be performed by simply counting each node's interpartition and intrapartition edges. In some cases, there may be more than one partitioning solution that increases the total number of interpartition edges for all partitions to a particular maximum number of interpartition edges. In such cases, an embodiment may use any method or consider any criteria desired by an implementer to select a particular partitioning, including making an arbitrary selection. Further iterations of the method of FIG. 7 will ultimately converge toward an optimal partitioning, even if individual iterations are not able to select a best-possible interim partitioning decision.

Step 720 initiates an inner iterative procedure of steps 720-760. The peer-selection system can perform this procedure once for each partition in the peer community or once for each pair of partitions in the peer community.

In step 730, the peer-selection system computes the total indegree of each peer in the partition or partitions under consideration during the current iteration of steps 720-760. This computation assumes the distribution of peers that exists after the peer-selection system performs the migrations of step 710.

For any particular peer, this computation may be as simple as identifying the number of incoming interpartition edges (positive votes) that represent votes for the peer submitted by peers represented by nodes contained in other partitions. If desired by an implementer, an embodiment may incorporate additional factors into this computation.

For example, in FIG. 5B:
peer 501 has a total indegree of 0 (no incoming edges directed from nodes in partition 5002B);
peer 502 has a total indegree of 1 (one incoming edge directed from node 504 of partition 5002B);
peer 503 has a total indegree of 0 (no incoming edges directed from nodes in partition 5002B);
peer 504 has a total indegree of 0 (no incoming edges directed from nodes in partition 5001B); and
peer 505 has a total indegree of 1 (one incoming edge directed from node 503 of partition 5001B);

One goal of the present invention is to partition the peer community to maximize each peer's total indegree and to then select a solution set of peers based on each peer's total indegree, rather than basing the selection on the total number of votes received by each peer. This approach reduces the likelihood that peers have colluded to generate biased voting results because the approach minimizes the biasing effect of excess or quid pro quo votes exchanged between members a subgroup of peers.

In step 740, the peer-selection system determines whether the number of peers associated with a positive total indegree equals or exceeds the maximum number of solution-set entries allocated to the current partition.

For example, if the partition currently being processed by the current iteration of steps 720-760 has been allocated five solution-set entries, the system in this step determines whether five or more peers in the current partition have a total indegree greater than zero.

Step 750 is performed if the current partition does not contain an allocated number of positive-value indegree peers. For example, if the current partition has been allocated five solution-set entries, the system would perform step 750 if the partition contains only four nodes that each have a total indegree greater than zero. In such a case, further processing will be required in order to ensure that the number of positive-indegree nodes within the partition is sufficient to fill all allocated entries in the solution set.

In this case, the system in step 750 partitions the current partition into two or more subpartitions in a manner similar to that performed in step 610. The number of solution-set entries in each of the subpartitions is also set by means of a procedure similar to that of step 610.

In one example, the current partition had contained 100 nodes (representing 100 peers) and had been allocated ten entries in the solution set. However, the indegree computations of step 730 had determined that only seven of the nodes were associated with total indegree values greater than zero.

In this example, the system would divide the partition into two subpartitions, each of which contain a mutually exclusive subset of the peers contained in the parent partition. As in step 610, the partitioning may be performed by any means desired by an implementer, including arbitrarily splitting the partition in half. Some embodiments may incorporate additional considerations in this step, if desired by an implementer, intended to reduce the likelihood that the partitioning does not produce optimized results. Such considerations might, for example, attempt to avoid a partitioning like that of FIG. 5B when an alternative partitioning, like that of FIG. 5C, would produce partitions that have a greater number of interpartition edges or a lower number of intrapartition edges.

If the peer-selection system determines in step 740 that the number of peers in the current partition associated with a positive total indegree equals or exceeds the maximum number of solution-set entries allocated to the current partition, then the system performs step 760.

In step 760, the system selects the allocated number of positive total indegree peers from the current partition and stops further processing of that partition. For example, if the current partition: i) contains 1200 peers; ii) contains six nodes that have a total indegree greater than zero; and iii) has been allocated six entries in the solution set, then the six peers represented by those six nodes would be added to the solution set required by the peer-selection event. If the partition contains more than six positive total indegree nodes, the system would select the six peers represented by nodes that have the six highest total indegree values. In case of a tie for sixth place, the system can use any method desired by an implementer to select six nodes from the total number of highest-indegree nodes. Such a method might, for example, select the sixth-place candidate that has the smallest number of intrapartition edges, that has the smallest number of outgoing interpartition edges, or that has most recently received its interpartition votes, or might simply select a node at random from the set of all nodes tying for sixth place.

At the conclusion of either step 750 or step 760, the iterative procedure of steps 720-760 repeats for the next partition, or pair of partitions, generated by the migration procedure of step 710. Once all partitions generated by the migration procedure of step 710 have been processed by iterations of steps 720-760, the outer iterative procedure of steps 700-760 is repeated upon the new set of partitions that includes the subpartitions generated by each performance of step 750.

In some embodiments, the outer procedure of steps 700-760 would be performed only on subpartitions created during instances of step 750 performed during the most recent iteration of steps 720-760.

At the conclusion of the final iteration of the procedure of steps 700-760, control is returned to step 630 of FIG. 6, where the peer-selection system assembles the positive-indegree nodes selected from all partitions into the solution set, and forwards the resulting solution set to the peer-selection management application or to downstream systems.

Examples and embodiments of the present invention described in this document have been presented for illustrative purposes. They should not be construed to be exhaustive nor to limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

What is claimed is:

1. A peer-selection system, of a peer-to-peer network, comprising a processor, a memory coupled to the processor, and a computer-readable hardware storage device coupled to the processor, the storage device containing program code configured to be run by the processor via the memory to implement a method for peer partitioning to reduce strategy-driven bias in automated peer-selection systems, the method comprising:
the system receiving, from a requesting application, notice of a peer-selection event that comprises a voting activity,
where each vote of the voting activity is cast by a voting peer, of a set of peer users of the peer-to-peer network, for a distinct voted peer of the set of peer users, and
where the voting activity selects a predefined number of peers, of the set of peer users, to be included in a solution set;
the system partitioning the set of peer users into two partitions;
the system reducing a total number of interpartition votes by migrating peers between the two partitions, where an interpartition vote is a vote in which the voting peer is contained in a different partition than the partition that contains the voted peer;
the system assigning an indegree value to each peer of the set of peer users;
the system determining, as a function of the indegree values, whether the partitioning is optimal, and, if determining that the partition is not optimal:
further partitioning each partition into two mutually exclusive next-generation partitions, and
repeating the migrating, the associating, and the determining upon each next-generation partition;
the system, if determining that the partition is optimal, populating the solution set with the peers to which have been assigned an indegree value greater than zero, and
the system returning the solution set to the requesting application.

2. The system of claim 1, where each partition is allocated a corresponding number of solution-set entries.

3. The system of claim 2,
where a first number of solution-set entries is allocated to a first partition, and
where a ratio of the first number to the predefined number is equal to a ratio of a number of peers in the first partition to a total number of peers in the set of peer users.

4. The system of claim 3,
where the partitioning is determined to be optimal if every partition contains a number of peers associated with an indegree value greater than zero that is equal to or greater than the number of solution-set entries allocated to that partition.

5. The system of claim 1, where a first indegree value of a first peer of the set of peer users is defined as a number of incoming interpartition votes cast for the first peer.

6. The system of claim 1,
where the migrating further comprises reducing a total number of intrapartition votes by migrating peers between the two partitions, and
where an intrapartition vote is a vote in which the voting peer and the voted peer are contained by a same partition.

7. The system of claim 1, where the requesting application is a crowdsourcing application.

8. A method for peer partitioning to reduce strategy-driven bias in automated peer-selection systems, the method comprising:
a peer-selection system of a peer-to-peer network receiving, from a requesting application, notice of a peer-selection event that comprises a voting activity,
where each vote of the voting activity is cast by a voting peer, of a set of peer users of the peer-to-peer network, for a distinct voted peer of the set of peer users, and
where the voting activity selects a predefined number of peers, of the set of peer users, to be included in a solution set;
the system partitioning the set of peer users into two partitions;
the system reducing a total number of interpartition votes by migrating peers between the two partitions, where an interpartition vote is a vote in which the voting peer is contained in a different partition than the partition that contains the voted peer;
the system assigning an indegree value to each peer of the set of peer users;
the system determining, as a function of the indegree values, whether the partitioning is optimal, and, if determining that the partition is not optimal:
further partitioning each partition into two mutually exclusive next-generation partitions, and
repeating the migrating, the associating, and the determining upon each next-generation partition;
the system, if determining that the partition is optimal, populating the solution set with the peers to which have been assigned an indegree value greater than zero, and
the system returning the solution set to the requesting application.

9. The method of claim 8, where each partition is allocated a corresponding number of solution-set entries.

10. The method of claim 9,
where a first number of solution-set entries is allocated to a first partition, and
where a ratio of the first number to the predefined number is equal to a ratio of a number of peers in the first partition to a total number of peers in the set of peer users.

11. The method of claim 10,
where the partitioning is determined to be optimal if every partition contains a number of peers associated with an indegree value greater than zero that is equal to or greater than the number of solution-set entries allocated to that partition.

12. The method of claim 8, where a first indegree value of a first peer of the set of peer users is defined as number of incoming interpartition votes cast for the first peer.

13. The method of claim 8,
where the migrating further comprises reducing a total number of intrapartition votes by migrating peers between the two partitions, and
where an intrapartition vote is a vote in which the voting peer and the voted peer are contained by a same partition.

14. The method of claim 8, further comprising providing at least one support service for at least one of creating, integrating, hosting, maintaining, and deploying computer-readable program code in the computer system, wherein the computer-readable program code in combination with the computer system is configured to implement the receiving, the partitioning, the reducing, the assigning, the determining, the populating, and the returning.

15. A computer program product, comprising a computer-readable hardware storage device having a computer-readable program code stored therein, the program code configured to be executed by a peer-selection system, of a peer-to-peer network, comprising a processor, a memory coupled to the processor, and a computer-readable hardware storage device coupled to the processor, the storage device containing program code configured to be run by the processor via the memory to implement a method for peer partitioning to reduce strategy-driven bias in automated peer-selection systems, the method comprising:
the system receiving, from a requesting application, notice of a peer-selection event that comprises a voting activity,
where each vote of the voting activity is cast by a voting peer, of a set of peer users of the peer-to-peer network, for a distinct voted peer of the set of peer users, and
where the voting activity selects a predefined number of peers, of the set of peer users, to be included in a solution set;
the system partitioning the set of peer users into two partitions;
the system reducing a total number of interpartition votes by migrating peers between the two partitions, where an interpartition vote is a vote in which the voting peer is contained in a different partition than the partition that contains the voted peer;
the system assigning an indegree value to each peer of the set of peer users;
the system determining, as a function of the indegree values, whether the partitioning is optimal, and, if determining that the partition is not optimal:
further partitioning each partition into two mutually exclusive next-generation partitions, and
repeating the migrating, the associating, and the determining upon each next-generation partition;
the system, if determining that the partition is optimal, populating the solution set with the peers to which have been assigned an indegree value greater than zero, and
the system returning the solution set to the requesting application.

16. The computer program product of claim 15, where each partition is allocated a corresponding number of solution-set entries.

17. The computer program product of claim 16,
where a first number of solution-set entries is allocated to a first partition, and
where a ratio of the first number to the predefined number is equal to a ratio of a number of peers in the first partition to a total number of peers in the set of peer users.

18. The computer program product of claim 17,
where the partitioning is determined to be optimal if every partition contains a number of peers associated with an indegree value greater than zero that is equal to or greater than the number of solution-set entries allocated to that partition.

19. The computer program product of claim 15, where a first indegree value of a first peer of the set of peer users is defined as a number of incoming interpartition votes cast for the first peer.

20. The computer program product of claim 15,
where the migrating further comprises reducing a total number of intrapartition votes by migrating peers between the two partitions, and
where an intrapartition vote is a vote in which the voting peer and the voted peer are contained by a same partition.
